(19) United States
(12) Patent Application Publication
(10) Pub. No.: US 2008/0249218 A1
(43) Pub. Date: Oct. 9, 2008

(54) Process for the manufacture of at least partially neutralized chlorosulfonated polyolefin elastomers in oil

(76) Inventors: Royce Elton Ennis, Silsbee, TX (US); Furman Eugene Glenn, Louisville, KY (US)

Correspondence Address: DUPONT PERFORMANCE ELASTOMERS L.L.C., PATENT RECORDS CENTER, 4417 LANCASTER PIKE, BARLEY MILL PLAZA P25, WILMINGTON, DE, 19805, US

(21) Appl. No.: 12/075,768

(22) Filed: Mar. 13, 2008

Related U.S. Application Data
(60) Provisional application No. 60/921,661, filed on Apr. 3, 2007.

(51) Int. Cl. C08K 5/09

(52) U.S. Cl. 524/284

(57) ABSTRACT

An oil concentrate comprising oil and one or more at least partially neutralized chlorosulfonated polyolefin elastomers containing 0.5-50 weight percent chlorine and 0.25 to 5 weight percent sulfur is disclosed.

### CROSS-REFERENCE TO RELATED APPLICATIONS

This application claims the benefit of U.S. Provisional Application No. 60/921,661 filed Apr. 3, 2007.

### FIELD OF THE INVENTION

This invention relates to preparation of partially neutralized chlorosulfonated polyolefin elastomers in oil wherein said chlorosulfonated polyolefin elastomers have a plurality of pendant —SO₃M groups, wherein M is a cation.

### BACKGROUND OF THE INVENTION

Chlorosulfonated polyethylene elastomers and chlorosulfonated ethylene copolymer elastomers have been found to be excellent elastomeric materials for use in applications such as wire and cable jacketing, molded goods, automotive hose, power transmission belts, roofing membranes and tank liners. These materials are noted for their balance of oil resistance, thermal stability, ozone resistance and chemical resistance.

Historically, a wide variety of polyolefin polymers, including ethylene homopolymers and copolymers, have been utilized as the starting polymers (i.e. “base polymers” or “base resins”) for manufacture of chlorosulfonated products. The majority of base polymers employed in the manufacture of chlorosulfonated elastomers have been polyethylene types, e.g. low density polyethylene (LDPE), linear low density polyethylene (LLDPE) and high density polyethylene (HDPE). Most of the ethylene homopolymers and copolymers employed to make these elastomers are polymerized by a high pressure free radical catalyzed process or by a low pressure process using Ziegler-Natta or Phillips type catalysts.

U.S. Pat. No. 5,668,220 discloses chlorinated and chlorosulfonated elastomers that contain 20-50 weight percent chlorine and 0.8-2.5 weight percent sulfur. These elastomers are made from ethylene/alpha-olefin copolymers that were polymerized in the presence of a single site or metallocene catalyst. Such ethylene copolymers have improved extrusion or flow properties when compared to polymers having the same molecular weight distribution, but produced using a Ziegler-Natta catalyst.

Japanese Kokai Hei 2[1990]-18681 discloses polyolefin ionomers containing —SO₃M groups, where M is a univalent cation. The ionomers are made by reacting a portion of the —SO₂Cl groups on a chlorosulfonated polyolefin with base. Chlorosulfonated polyethylene is described as having between 25-36% chlorine.

Ethylene based elastomers (e.g. EP and EPDM) are utilized as viscosity modifiers for oils in automotive and industrial applications. These polymers are readily soluble and stable in paraffinic and naphthenic oils whereas more polar polymers (e.g. ethylene acrylic or methacrylic copolymers and highly chlorinated ethylene polymers) are not.

Isobutylene based elastomers (e.g. PIB and isobutylene/diene copolymers) have traditionally been used as modifying agents for motor oils and greases to enhance their utility at higher temperatures.

Styrene based elastomers (e.g. SBS and SIS block copolymers and preferably their hydrogenated derivatives) have also shown application as viscosity modifiers in oil formulations and adhesives applications.

Propylene based polymers (e.g. atactic polypropylene and propylene/ethylene copolymers) have been utilized as adhesives and bonding agents as well as viscosity modifiers in industrial applications.

Many of these polymers are functionalized, via grafting techniques, with reactive groups (e.g. maleic anhydride) in order to incorporate stabilizers for oil-based formulations. These modified functionalized polymers enhance oil stability and prevent deposit formation in equipment.

These polymers normally require extended periods of dissolution time when being added to oils due to residual crystallinity that must be overcome and/or the need to breakup the high molecular weight polymer through difficult polymer grinding techniques before addition to the oil.

It would be desirable to have an oil based solution or emulsion concentrate of partially neutralized chlorosulfonated elastomeric polyolefins (i.e. ionomers) having 0.5 to 50 weight percent chlorine and a moderate to low level of residual crystallinity for use in oil based solutions and emulsions. These solutions or emulsion rapidly dissolve or disperse in oils to greatly reduce formulation preparation. In some of these applications where solution viscosity must be balanced with oil solubility, polymer thermal stability and detergency, it would be desirable to employ a mixture of copolymers.

### SUMMARY OF THE INVENTION

An aspect of the present invention is a process for the manufacture of an oil composition comprising one or more at least partially neutralized chlorosulfonated polyolefin elastomers, said process comprising:

A) providing a pre-mixture comprising at least one chlorosulfonated polyolefin elastomer, oil, base and up to 30 weight percent water, based on total weight of said pre-mixture; and

B) shearing said pre-mixture at a sufficient shear and for a sufficient time to form a stable dispersion comprising at least one chlorosulfonated polyolefin elastomer having a plurality of —SO₃M groups, wherein M is a cation.

Another aspect of the invention is a stable oil concentrate dispersion comprising:

A) oil; and

B) 5 to 50 weight percent, based on total weight of concentrate, of at least one chlorosulfonated polyolefin elastomer comprising 0.5 to 50 weight percent chlorine, 0.25 to 5 weight percent sulfur and a plurality of —SO₃M groups, wherein M is a cation.

### DETAILED DESCRIPTION OF THE INVENTION

The oil concentrate of this invention, comprising oil and one or more at least partially neutralized chlorosulfonated polyolefin elastomers, is made by neutralizing with base a portion of the pendant —SO₂Cl groups on at least one chlorosulfonated polyolefin elastomer. Typically only about 10 to 90% (as evidenced by FTIR measurements or titration analysis) of the —SO₂Cl groups react with base to form a plurality of —SO₃M groups, so that the elastomers are termed “partially neutralized”. However, fully neutralized elastomers are also considered part of the invention. The cation, M, originates with the base employed in the neutralization reaction and may be univalent or multivalent. M is preferably either sodium or potassium ion.

Oil that may be employed in this invention includes, but is not limited to mineral oil, paraffinic oil, diesel oil and naphthenic oil.

Chlorosulfonated polyolefin elastomers suitable for use in this invention are those made from base resins selected from the group consisting of ethylene homopolymers, copolymers of ethylene and a C₃-C₂₀ alpha olefin, propylene/ethylene copolymers, ethylene/propylene/diene copolymers, isobutylene/diene copolymers, isobutylene homopolymers, hydrogenated styrene/butadiene block copolymers and hydrogenated styrene/isoprene block copolymers. Base resins of high density polyethylene, linear low density polyethylene, ethylene/propylene/diene copolymers, and isobutylene/diene copolymers are preferred. Some of these chlorosulfonated polyolefin elastomers are available under the trade name Hypalon® from DuPont Performance Elastomers. Other chlorosulfonated polyolefin elastomers may be made from the above base resins by any of the various chlorosulfonation processes well known in the art. For example, those disclosed in U.S. Pat. Nos. 3,624,054; 5,668,220; 4,560,731 and EP 131948 A1.

These chlorosulfonated polyolefin elastomers may be semi-crystalline or amorphous. They contain between 0.5 and 50 (preferably between 0.75 and 20, most preferably between 1 and 10) weight percent chlorine and between 0.25 and 5 (preferably between 0.35 and 3, most preferably between 0.5 and 2) weight percent sulfur.

In the general neutralization process, a chlorosulfonated polyolefin elastomer, oil, base and up to 30 weight percent water, based on total weight of pre-mixture, are combined in a pre-mixture. Optionally, only enough water is present to dissolve the base. If excessive water is present, problems with dispersion stability may arise. If not enough water is present to dissolve the base, or if the base does not have high water solubility, incomplete utilization of the base (and less neutralization of —SO₂Cl groups on the polymer) may occur.

The pre-mixture is exposed to high shear mixing in order to form a stable dispersion or solution. Examples of high shear mixing devices include Silverson homomixers and other commercial devises designed for intensive mixing of high viscosity materials. Neutralization of the chlorosulfonated polyolefin elastomer may begin during formation of the pre-mixture. However, the neutralization reaction may continue in the resulting dispersion after mixing is competed.

Preferably during high shear mixing, the crystalline regions in semi-crystalline chlorosulfonated elastomer are melted in order to promote neutralization of pendant —SO₂Cl groups present in crystalline regions. Heating the pre-mixture to above the melting point of these crystalline regions may be accomplished by heat generated from mixing (shear heating) or by an external heat source.

Optionally, rather than beginning the neutralization process with a solid chlorosulfonated polyolefin elastomer that must be dissolved in the oil, a “solvent exchange process” may be employed. In this process, a chlorosulfonated polyolefin elastomer that is already dissolved in a solvent (e.g. carbon tetrachloride, ethylene trichloride, xylene, etc.) is added to the oil in order to exchange the solvent with oil.

The base that is employed in the neutralization process may be a strong base, e.g. sodium hydroxide, potassium hydroxide, lithium hydroxide, magnesium hydroxide, calcium hydroxide, aluminum hydroxide, a moderate base, e.g. sodium carbonate, calcium carbonate or weak base such as the sodium salt of a fatty acid or a tertiary amine. The amount of base added to the pre-mixture is typically between 0.5 and 2.5 molar equivalents of base per equivalent of —SO₂Cl groups on the copolymer.

Preferably, the pre-mixture also contains a compatibilizer (e.g. a surfactant or transfer agent) that facilitates neutralization of the pendant —SO₂Cl groups on the chlorosulfonated polyolefin elastomer. More than one compatibilizer may be employed. Specific examples of suitable compatibilizers include, but are not limited to anionic surfactants (e.g. sodium lauryl sulfate), metal stearates (e.g. sodium stearate), a metal rosin soap, stearic acid, lauryl alcohol, a non-ionic surfactant (e.g. Triton® X-100), or a quaternary ammonium salt (e.g. Quartamin® 24P, available from Kao Corporation). The presence of a compatibilizer is especially useful when the base employed in the neutralization process is not very soluble in water, e.g. CaO or CaCO₃.

Optionally, base, demineralized water and compatibilizer may be admixed to form a solution or emulsion before addition to an oil-chlorosulfonated polyolefin elastomer admixture.

The resulting dispersion is stable, i.e. it does not form separate layers when stored at room temperature for 24 hours.

Preferably, the dispersion is in the form of a concentrate comprising oil and 5 to 50 weight percent of partially neutralized chlorosulfonated polyolefin elastomer, based on total weight of the concentrate. When used in oil formulations, the concentrate may be easily introduced to the formulation at the appropriate (usually diluted) level of partially neutralized chlorosulfonated elastomer.

Concentrates may be packaged (e.g. in drums, pails, bulk container, etc.) by a variety of techniques for distribution and sales, or stored in containers for onsite formulation preparation.

The concentrates of this invention have a variety of end uses such as viscosity modifiers and also for use in adhesives, compatibilizers, cured and uncured elastomeric systems, impact modifiers and organosol components. Concentrates are especially useful in facilitating the manufacture of oil formulations wherein a solid partially neutralized chlorosulfonated polyolefin elastomer was traditionally used.

Compounds utilizing the concentrates of the invention may be formulated to contain curatives and other additives typically employed in traditional chlorosulfonated polyolefin compounds.

Useful curatives include bismaleimide, peroxides (e.g. Di-Cup®), sulfur donors (e.g. dithiocarbamyl polysufides) and metal oxides (e.g. MgO).

Examples of additives suitable for use in the compounds include, but are not limited to i) fillers; ii) plasticizers; iii) process aids; iv) acid acceptors; v) antioxidants and vi) antiozonants.

### EXAMPLES

### Test Methods

Weight percent Cl and S incorporated in chlorosulfonated polyolefin elastomers was measured by the Schoniger combustion method (J. C. Torr and G. J. Kallos, American Industrial Association J. July, 419 (1974) and A. M. MacDonald, Analyst, v86, 1018 (1961)).

The percent of —SO₂Cl groups converted to —SO₃M groups was estimated utilizing Infrared Spectroscopy techniques by examination of the absorption regions for the —SO₂Cl and —SO₃M groups.

### Example 1

A master 1.5 weight percent (wt. %) solution of a chlorosulfonated ethylene/octene polyolefin elastomer containing 0.98 wt. % combined sulfur and 1.81 wt. % combined chlorine (derived from Engage® 8150, available from The Dow Chemical Co., having a melt index of 0.5 g/10 minutes and a density of 0.868 g/cm³) was prepared by dissolving 15 grams of elastomer in 985 grams of mineral oil. This was accomplished by placing the elastomer into the oil and then heating the mixture to 50° C. in an oven prior to intensively mixing for 5 minutes using a Silverson L4R homogenizer at high speed. This solution was divided into 10 equal aliquots, held at 50° C. and treated as follows:
Sample A—No treatment (control).
Sample B—0.1 g of stearic acid added (control).
Sample 1—0.15 g of calcium oxide and 3 ml of water added.
Sample 2—0.1 g of stearic acid, 0.15 g of calcium oxide and 3 ml of water added.
Sample 3—0.1 g of sodium hydroxide and 3 ml of water added.
Sample 4—0.1 g of stearic acid, 0.1 g of sodium hydroxide and 3 ml of water added.
Sample 5—0.1 g of stearic acid, 0.15 g of sodium carbonate and 3 ml of water added.

After additions were made, all samples were mixed using a Silverson L4R homomixer for 5 minutes at an initial starting temperature of 50° C. After 5 minutes of mixing, the temperature had risen to 72° C. The samples were then set aside and allowed to cool to 25° C. (approximately 1 hour) in a constant temperature bath. Viscosity of the samples was measured with a Brookfield viscometer (model LVDV-11 with a #2 spindle) as soon as the temperature reached 25° C. (original viscosity) and then again after 1 hour and 16 hours storage at 25° C. (TABLE I).

Additional control samples (C and D) were made as above by adding 1.5 g of the ethylene/octene copolymer utilized to prepare the chlorosulfonated copolymer above to 98.5 g of mineral oil. To Sample C was added 0.1 g of stearic acid and 3 ml of water. To Sample D was added 0.1 g of sodium hydroxide, 0.1 g of stearic acid and 3 m of water. These samples were mixed as above and allowed to cool to 25° C. Viscosities were measured as soon as the temperature reached 25° C. and then again after 1 hour and 16 hours. Results are shown in TABLE I.

TABLE I

| | Visc. Original, | Visc. After 1 Hr., | Viscosity after 16 |
|---|---|---|---|
| Sample No | cps. | cps. | Hrs, cps. |
| A | 2.3 | 2.5 | 2.3 |
| B | 3.0 | 3.5 | 4.1 |
| 1 | 2.5 | 2.7 | 3.4 |
| 2 | 7.3 | 16.4 | 22.6 |
| 3 | 2.9 | 8.9 | 9.1 |
| 4 | 23.6 | 39.5 | 164 |
| 5 | 8.6 | 14.8 | 24 |
| C | 1.5 | 1.7 | 1.6 |
| D | 2.5 | 2.4 | 2.6 |

The polymers, after 16 hours, were isolated from mineral oil by non-solvent precipitation and analyzed by FTIR. Samples 2, 4 and 5 were shown to have significant peaks at 1049 cm⁻¹ indicating the presence of sulfonate salts.

### Example 2

Samples A, B, 1 and 2 of Example 1 were repeated except that the oil used was diesel oil, rather than mineral oil. The viscosity results, after mixing and standing at 25° C. for one hour, are shown in TABLE II.

TABLE II

| | Brookfield viscosity |
|---|---|
| Sample Number | after 1 hr.-Cps |
| A | 0.5 |
| B | 0.4 |
| 1 | 0.7 |
| 2 | 3.1 |

### Example 3

Two 6 wt. % solutions of chlorosulfonated ethylene/octene-1 copolymer were prepared by dissolving 6 g of chlorosulfonated ethylene octene elastomer (containing 0.98 wt. % sulfur and 1.8 wt. % chlorine) in 94 grams of mineral oil as described in Example 1. The samples were mixed at high speed for 5 minutes.

The first solution (Control Sample E) was set aside to cool to 25° C. Viscosity, by Brookfield viscometer, of the resulting solution after 1 hour at 25° C. was 20 cps.

To the second solution was added 0.3 g of stearic acid; 9 ml of water and 0.3 g of sodium hydroxide (Sample 9 of the invention). This was mixed as described in Example 1. Immediately upon mixing a very viscous paste was formed. The viscosity of the paste was so high that it could not be measured with the Brookfield viscometer.

### Example 4

### Preparation of Chlorosulfonated EP Polymer in Oil Solution

A 4 wt. % oil solution of a chlorosulfonated ethylene propylene copolymer was prepared by adding 8 g (in small pieces) of chlorosulfonated ethylene propylene copolymer having a chlorine content of 3.3 wt. % and sulfur content of 0.65 wt. % (derived from Tafmer® P 0080, available from Mitsui Chemicals, Inc., having a melt flow rate@230° C. of 40 g/10 minutes (min.) and a density of 0.870 g/cc) to 200 g mineral oil (Total DF-1 available from TotalFina Great Britain Limited) with mild agitation for one hour at room temperature to ensure that all of the chlorosulfonated polymer was in solution.

Preparation of Caustic Emulsion with Phase Transfer Agent:

A caustic-containing emulsion was prepared by mixing 5 g of 50 wt. % sodium hydroxide, 10 g of water and 0.5 g of a quaternary ammonium salt phase transfer agent (bis(2-hydroxy propyl)benzyl coco ammonium chloride) and 25 g of mineral oil (Total DF-1) with a Silverson homomixer for 3 minutes at 3,000 rpm.

### Preparation of Partially Neutralized Chlorosulfonated EP Polymer in Oil Concentrate:

2.5 g of the above caustic emulsion was added to the above polymer in oil solution and the total mixture was mixed with a Silverson homomixer at 3000 rpm for 5 minutes. The resulting 3.8 wt. % partially neutralized chlorosulfonated EP polymer in oil concentrate was set aside for future use. The concentrate exhibited thixotropic behavior being fluid under mixing but becoming a very thick paste after stirring had stopped. The paste concentrate became fluid again when mixed with the homomixer.

Approximately 10 g of this resulting concentrate was then added with agitation into 50 ml of acetone and agitated for 5 minutes to obtain a polymer sample. The polymer was separated and washed 3 times with 50 ml of acetone and then dried. FTIR analysis showed that the sulfonyl chloride group had been substantially converted to the sodium sulfonate salt by the appearance of a peak at 1051 cm⁻¹ and a shift of the sulfonyl chloride peak at 1161 cm⁻¹ to 1182 cm⁻¹.

### Example 5

### Preparation of 20 wt. % Fatty Acid Salt Concentrate

A fatty acid sodium salt concentrate was prepared by adding 150 g of Westvaco 1408 fatty acid (1480 is a tall oil derivative with an equivalent weight of 280 g/equivalent obtained from the Westvaco Company) to 750 g of water and then, while stirring, adding 40 g of 50 wt. % aqueous sodium hydroxide. The solution was stirred for 1 hour at 50° C. to form a waxy material containing 20 wt. % sodium salt and 80 wt. % water. This material was set aside for further use.

### Preparation of Chlorosulfonated EP Polymer in Oil Solution:

4 g of chlorosulfonated ethylene/propylene copolymer having a chlorine content of 4.2 wt. % and a sulfur content of 0.88 wt. % (derived from Tafmer® P 0080, available from Mitsui Chemicals, Inc., having a melt flow rate@230° C. of 40 g/10 min. and a density of 0.870 g/cc) was dissolved in 140 g mineral oil (EDC 95/11 available from Total Fluides) by shaking on a shaker for 1 hour at room temperature. The resulting oil solution contained 2.8 wt. % polymer

### Preparation of Partially Neutralized Chlorosulfonated EP Polymer in Oil:

The above 2.8 wt. % polymer in oil solution was then mixed with a Silverson homomixer for several minutes at 1700 rpm. Then over a 5 minute period, 1.7 grams of the above 20 wt. % fatty acid salt concentrate, 5 grams of a 2 wt. % sodium carbonate solution and 5 ml of additional water were added to the solution while mixing with the homo mixer. Mixing was continued for 30 minutes resulting in a thick 2.6 wt. % at least partially neutralized chlorosulfonated EP polymer in oil concentrate which contained 7.2 wt. % water. The concentrate exhibited thixotropic behavior being fluid under mixing but becoming very thick and paste-like after stirring had stopped.

A small sample of the resulting concentrate (about 10 g) was then added with agitation to 50 ml of acetone and then agitated for 5 minutes to obtain a polymer sample. The polymer was separated and washed 3 times with acetone and dried. The isolated sample was analyzed by FTIR to determine the degree of hydrolysis. Essentially complete hydrolysis was indicated by formation of a peak at about 1050 cm⁻¹ (which is characteristic of the sodium sulfonate salt) and a shift of the normal sulfonyl chloride peak at 1161 cm⁻¹ to 1182 cm⁻¹.

### Dilution of Concentrate:

10 g of the above 2.6 wt. % partially neutralized chlorosulfonated EP polymer in oil concentrate was added to 20 g of mineral oil (EDC 95/11) over a 2 minute period while agitating with a Silverson Homomixer at 3,000 rpm. The resulting 0.86 wt. % solution was stable upon standing, fluid and pourable. The solution still exhibited thixotropic behavior being very fluid under mixing but becoming very thick but pourable after stirring had stopped.

What is claimed is:

1. A process for the manufacture of an oil composition comprising one or more at least partially neutralized chlorosulfonated polyolefin elastomers, said process comprising:
A) providing a pre-mixture comprising at least one chlorosulfonated polyolefin elastomer, oil, base and up to 30 weight percent water, based on total weight of said pre-mixture; and
B) shearing said pre-mixture at a sufficient shear and for a sufficient time to form a stable dispersion comprising at least one chlorosulfonated polyolefin elastomer having a plurality of —SO₃M groups, wherein M is a cation.

2. A process of claim 1 wherein said pre-mixture further comprises at least one compatibilizer selected from the group consisting of anionic surfactants, non-ionic surfactants, metal stearates, metal rosin soaps, strearic acid, lauryl alcohol and quaternary ammonium salts.

3. A process of claim 2 wherein said pre-mixture is made by a process comprising:
i) combining at least one chlorosulfonated polyolefin elastomer with oil to form a first admixture;
ii) combining base, water and at least one compatibilizer to form a second admixture; and
iii) combining said first and second admixtures to form said pre-mixture.

4. A process of claim 1 wherein said pre-mixture is made by combining at least one solid chlorosulfonated polyolefin elastomer with oil, base and up to 30 weight percent water.

5. A process of claim 1 wherein said base is selected from the group consisting of sodium hydroxide, potassium hydroxide, lithium hydroxide, sodium carbonate, calcium carbonate, calcium oxide, magnesium oxide, calcium hydroxide, a sodium salt of a fatty acid and a tertiary organic amine.

6. A process of claim 1 wherein said oil is selected from the group consisting of mineral oil, paraffinic oil, diesel oil, and naphthenic oil.

7. A process of claim 1 wherein said chlorosulfonated polyolefin is made from a polyolefin selected from the group consisting of ethylene homopolymers, copolymers of ethylene and a C₃-C₂₀ alpha olefin, propylene/ethylene copolymers, ethylene/propylene/diene copolymers, isobutylene/diene copolymers, isobutylene homopolymers, hydrogenated styrene/butadiene block copolymers and hydrogenated styrene/isoprene block copolymers.

8. A process of claim 7 wherein said polyolefin is an ethylene homopolymer.

9. A process of claim 7 wherein said polyolefin is a copolymer of ethylene and a C₃-C₂₀ alpha olefin.

10. A process of claim 7 wherein said polyolefin is an ethylene/propylene/diene copolymer.

11. A process of claim 7 wherein said polyolefin is an isobutylene/diene copolymer.

12. A stable oil concentrate dispersion comprising:
A) oil; and
B) 5 to 50 weight percent, based on total weight of concentrate, of at least one chlorosulfonated polyolefin elastomer comprising 0.5 to 50 weight percent chlorine, 0.25 to 5 weight percent sulfur and a plurality of —SO₃M groups, wherein M is a cation.

13. An oil concentrate of claim 12 wherein said oil is selected from the group consisting of mineral oil, paraffinic oil, diesel oil, and naphthenic oil.

14. An oil concentrate of claim 12 wherein said chlorosulfonated polyolefin elastomer is made from a polyolefin selected from the group consisting of ethylene homopolymers, copolymers of ethylene and a C₃-C₂₀ alpha olefin, propylene/ethylene copolymers, ethylene/propylene/diene copolymers, isobutylene/diene copolymers, isobutylene homopolymers, hydrogenated styrene/butadiene block copolymers and hydrogenated styrene/isoprene block copolymers.

15. An oil concentrate of claim 12 wherein said chlorosulfonated polyolefin elastomer comprises 0.75 to 20 weight percent chlorine, 0.35 to 3 weight percent sulfur and a plurality of —SO₃M groups.

16. An oil concentrate of claim 15 wherein said chlorosulfonated polyolefin elastomer comprises 1 to 10 weight percent chlorine, 0.5 to 2 weight percent sulfur and a plurality of —SO₃M groups.
